(19) United States
(12) Patent Application Publication
(10) Pub. No.: US 2003/0009425 A1
(43) Pub. Date: Jan. 9, 2003

(54) System and method for on-demand digital media production and fulfillment

(76) Inventors: Dale Stonedahl, Boulder, CO (US); Blair Zykan, Centennial, CO (US); Amy Tumath, Lyons, CO (US); Alex de St. Simon, Boulder, CO (US); Jeffrey Sloan Pedigo, Boulder, CO (US)

Correspondence Address: Stuart T. Langley, Esq., Hogan & Hartson, LLP, Suite 1500, 1200 17th Street, Denver, CO, 80202, US

(21) Appl. No.: 10/165,418

(22) Filed: Jun. 7, 2002

Related U.S. Application Data
(60) Provisional application No. 60/296,790, filed on Jun. 8, 2001.

(51) Int. Cl. G06F 17/60

(52) U.S. Cl. 705/51

(57) ABSTRACT

A controller for managing storage, duplication and distribution of digital content on physical media. An interface receives order messages comprising order data from a network, where each order message specifies content and specifies order preferences. Other order preferences and specifications may be predefined and known to the system. A duplicator in communication with the interface operates to place the order-specified content onto the physical media in accordance with the specified order preferences. A labeler places a label and identifying indicia on the data disk, where the indicia creates an association between the order data and the disk. At least one post-duplication process is automated using the order data accessed through the identifying indicia.

### CROSS-REFERENCE TO RELATED APPLICATIONS

This application claims the benefit of U.S. Provisional Application No. 60/296,790 filed Jun. 8, 2001, the disclosure of which is herein specifically incorporated in its entirety by this reference.

### BACKGROUND OF THE INVENTION

1. Field of the Invention

The present invention relates, in general, to digital media production and, more particularly, to the on-demand, customizable production and distribution of digital media.

2. Relevant Background.

The reproduction of fixed, optical storage media such as compact disks (CDs) and digital video disks (DVDs) involves replication and/or duplication. In the replication process, a master is made with all the digital content in a fixed arrangement and then copies are replicated by stamping the master onto blank CD or DVD. In duplication, digital content is burned onto a blank CD-R (compact disk, recordable) or DVD-R with a laser.

The cost effectiveness of replication versus duplication depends on the number of copies to be made. A master used in replication is an expensive fixed cost, but the stamping or molding process is much faster and therefore lower cost per copy. As a result, copying via replication is cost effective when many copies are required. On the other hand, if only a single copy or small number of copies are required, then duplication, which may take several minutes per copy, is more cost effective.

Increasingly, consumers and businesses demand customized content on CDs and DVDs. The customized content selects the content and arrangement of the content on the media to meet the demands of a particular user or application. Customized content is cost prohibitive to provide with replication techniques. For example, while in the past music consumers were satisfied with purchasing identical copies of a mass-produced music CD, today they increasingly desire personalized music CDs that only contain the consumer's favorite songs. This consumer demand, which has not been satisfied by the music industry, has encouraged many consumers to create their own CDs at home using inexpensive CD burning hardware and software. Unfortunately, this desire on the part of the music consumer for customized content has created friction with the producers of music CDs and DVDs who fear a loss of control over the branding of their products as well as the piracy of their intellectual property, thereby creating a need for these industries to provide customizable products in controlled manner.

In another example, businesses are increasingly using CDs and DVDs to distribute information (e.g., software, manuals, documentation, and the like) and marketing materials to customers and prospective customers. Oftentimes, the individualized nature of these materials means that relatively few identical copies of a CD or DVD are made, and replication is cost prohibitive. As a result, operations are set up within the business to produce and distribute the media. On the other hand, business desire high quality packaging and labels that are typical for professionally replicated CDs and DVDs. This professional look is difficult to reproduce with small “in-house” operations. Moreover, the cost of producing and distributing media within a business remains significant.

A wide variety of businesses capture, archive, and/or distribute voluminous data such as bill images, check images, account statements, and the like. Many applications for microfiche records can be improved by digitized storage rather film-based storage. Producing and distributing such record collections has been expensive and problematic. The set of records or images compiled on a particular CD will change based on the recipients. Also, the set of recipients will change for any given collection of records/images. Accordingly, there is a need for a system to readily enable the recordation of custom-content CDs with customizable and automated distribution.

In another example, the rise of high-resolution digital photography has created a growing market for the storage and transport of digital picture and map information. Unfortunately, the relatively large amount of data associated with high-resolution digital pictures makes it difficult to transport them across the Internet. Duplicatable CDs and DVDs have proven to be a desirable solution for the bulk transport of digital content, but oftentimes lack high quality packaging and labeling when produced at home or in small businesses with conventional CD duplicating and labeling equipment. Hence, there is a need for a system and method of cost effectively producing customized data disks like CDs and DVDs with high quality packaging and labeling. Such a system and method would combine the high quality packaging and labeling of CDs and DVDs that typify professional replication, but can be done cost effectively for a relatively low number of copies like duplication.

Although disk replication services are available, they are difficult to use for many business applications because there is no convenient, efficient mechanism for transporting business-specific content and orders to the replication service. Particularly in applications where a client of the business is configuring an order for the CD, there is no effective mechanism to convey the client's order to a disk replication service without significant manual involvement.

### SUMMARY OF THE INVENTION

Briefly stated, the present invention involves a controller and methods for operating a controller for managing storage, duplication, labeling, packaging and distribution of digital content on physical media. An interface receives order messages comprising order data from a network, where each order message specifies content and specifies order preferences. Content specifications and preference specifications may include content/preferences that are included in the order, or pointers to content/preferences that are previously stored in the system. A duplicator in communication with the interface operates to place the order-specified content onto the physical media in accordance with the specified order preferences. A labeler places a label and identifying indicia on the data disk, where the indicia creates an association between the order data and the disk. At least one post-duplication process is automated using the order data accessed through the identifying indicia.

### BRIEF DESCRIPTION OF THE DRAWINGS

FIG. 1 shows a distributed computing environment in which the present invention is implemented;

FIG. 2 illustrates an example of a functional system architecture diagram for allowing a web user to create a customized disk;

FIG. 3 illustrates another example of a functional system architecture diagram for allowing a web user to create a customized disk;

FIG. 4 illustrates an example of a functional system architecture diagram for producing a customized disk;

FIG. 5 illustrates another example of a functional system architecture diagram for allowing a web user to create a customized disk; and

FIG. 6 shows an example of a customized disk label layout in accordance with the present invention.

### DETAILED DESCRIPTION OF THE PREFERRED EMBODIMENTS

While the invention is susceptible to various modifications and alternative forms, specific embodiments thereof are shown by way of example in the drawings above, and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

The present invention is directed to a system that controls or governs the operation of various systems and subsystems used to manufacture (e.g., produce, label, package, and distribute) media-based storage (e.g., CDROMs, DVDs, magnetic disks, magnetic tape, optical tape and the like). These systems are available in a variety of configurations from a variety of manufactures and may be integrated or provided as stand-alone, assembly-line systems. Significantly, many of the manufacturing processes involve process variables that determine specifically how an operation is carried out. The aggregate of these process variables ultimately determine the features of the media-based storage that is provided to a recipient.

The present invention is described specifically in terms of compact disc (CD) production, however, is readily applied to many media-based storage mechanisms. Hence, throughout this specification references to “disk”, “data disk”, “CD”, “DVD” and the like are intended to include analogous and equivalent media formats such as disk, tape, and the like using magetic, optical, magneto-optical, and other recording technologies. Moreover, the present invention can be implemented with various solid state media such as read only memory (ROM), programmable read only memory (PROM), ferroelectric memory, and the like, which are generally considered equivalent to disk-based media in many applications.

End-users dynamically specify content selected from both pre-stored content and uploaded content, to produce custom CDs. Alternatively, content may be specified implicitly based upon other order data, such as recipient address. For example, an order may specify a selection of legal forms, where the specific legal form added to the customized CD is chosen based on the recipient's locale.

In addition to content selections, the user and/or content provider are enabled to specify a variety of preferences indicating the manner in which the production, packaging, labeling, and distribution are performed. In this manner almost any process in the media-based storage production can be performed according to user specifications allowing the user control over the media type, media shape, content, content format, labeling, packaging, shipping options and the like. Conversely, a content owner or other interested party can constrain any of these process variables to simplify the user's choices and/or control the manner in which the content is provided.

User content selections and preferences are packaged together into an order message that can be readily transported across public and private networks to a production facility in accordance with the present invention. The orders may be sent directly by a user using, for example, a web browser, or may be sent indirectly through a third party server or digital storage media such as tape. In the later case the production facility resources can be shared by any number of third party servers allowing for great economies of scale, while at the same time allowing the third party server to manage the user interaction as if it were producing and distributing the media itself.

The CDs as defined by a user are produced on-demand to end-user specifications, including content selection, arrangement, labeling and shipping. In particular embodiments the production system includes a world-wide-web (“web”) interface that supports orders and content uploads from end-users directly through a web browser or indirectly through another application server, web server or online service. These specific implementations, however, are merely suggestive of a variety of implementations that are possible in a networked computing environment.

As the terms appear in this specification, “Users” are people who use the present invention to place orders for customized data disks. A user who places an order over the Internet is referred to as a “web user”. A “third-party partner” is an individual or organization that provides content for users to have copied onto a customized data disk. The third-party partners can also supply label content for the customizable disks and/or packaging templates, shipping preferences, and various other preferences that are applied to user-generated orders as they are manufactured. Third-party partners can also be users, and vice versa.

The customized data disk refers to fixed, digital storage media. Disks include conventional circular disks as wells as shaped media that can be accessed using CD and/or DVD players and the like. Examples of customized data disks include compact disks (CDs), and digital video disks (DVDs), among others. The present invention is readily adapted to use CD-R, CD-WR, DVD-R, DVD-RW, and Dataplay® technologies, as well as other available optical, magnetic, magneto-optic, or similar media technologies. It should be noted that the content stored on a customized disk may include digital data of any type, format and combination, including text, graphic, music, video, multimedia, computer program, among others data types.

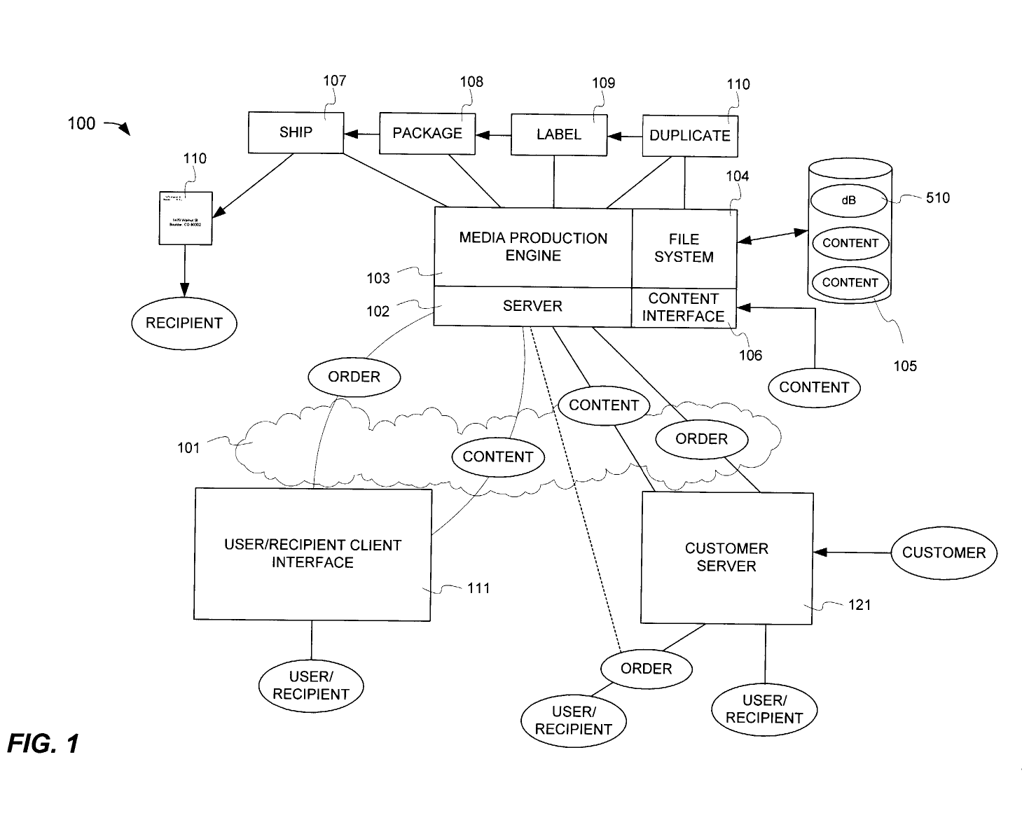

FIG. 1 illustrates a distributed computing environment 100 in which an embodiment of the present invention is implemented. The example of FIG. 1 involves data communication with user, third-party partner web sites, and recipients through a private or public data communication network such as Internet 101. The on-demand digital media production services in accordance with the present invention are accessed via a server-implemented interface 102 such as a web server via a communication network 101 such as a local area network (LAN), wide area network (WAN), or public network such as Internet 101 in the particular examples.

The present invention contemplates “user-direct” or “consumer” interactions that are largely conducted through a client interface 111. In this “client-toserver” embodiment, client interface 111 interacts with a server 102 that accesses the media-based storage manufacturing, production and delivery in accordance with the present invention. In a particular implementation, client interface 111 is implemented by a web-browser. Client interface 111 is operated by a system user to upload content and/or orders that define the content and manner in which a customized CD is to be produced. The user may also be a recipient who receives digital media 110 once it is produced. Alternatively, an order may specify any number of recipients irrespective of whether those recipients are users.

The present invention also contemplates a “user-indirect” or “commercial” interface in which orders are placed through a third party server 121. This implementation is also referred to as a “server-toserver” implementation. For example, server 121 may be implemented as a customer web site allowing users to select and/or order customized CD's that will be manufactured and distributed by the systems in accordance with the present invention.

Although not shown in FIG. 1, a user or user/recipient interacts with server 121 through an interface similar to client interface 111. For example, a web browser may be used in either case as a client interface 111. Alternatively, any software application that provides user interaction may be adapted to serve as a client interface 111. For example, a word processing program, spreadsheet program, presentation program, publishing program, database program and the like can be extended to send content and/or orders to server 102/121. This may be implemented, for example, by placing a user-operable control in the programs user interface that initiates processes for order message generation and/or content upload.

Order generation processes may be implemented on the client interface 111, customer server 121 or by server 102. In a particular example, order messages are implemented in extensible markup language (XML). The order generation processes involve processes for capturing user input, generating properly formed XML order messages embedding the user input, and sending the messages over an appropriate communication protocol. Order generation processes may also include processes for receiving notifications (e.g., order receipt confirmation, confirmation of shipment and the like), which may be provided in real-time or near real time.

The user's interaction may be entirely directed through customer server 121 or may be redirected in part directly to server 102 to meet the needs of a particular application. Hence, the user may or may not be aware that the order placed is actually satisfied by the systems in accordance with the present invention. In this manner, the manufacturing and distribution systems managed by the present invention can be shared by many independent customers, while allowing each customer to manage their user interactions as desired.

Content may be uploaded via server 121, however, it is expected that in many commercial applications it will be preferred to transfer data in an out-of-band manner to content interface 106. Content interface 106 supports a variety of data transport mechanisms including electronic transmission (e.g., file transfer protocol, hypertext transfer protocol), as well as physical transport modes (e.g., digital tape, CDROM, DVDROM, hard disks, and the like). Moreover, content interface 106 preferably supports a variety of hardware platforms, operating system platforms and data formats as needed to meet the needs of a particular application.

In operation, content is loaded by upload or content interface 106 and stored through file system 104 to data store 105. Orders received by server 102 are validated and passed to media production engine 103 for processing. Orders may themselves contain content which can be used in the media production operations alone or in combination with content stored in data store 105. Orders specify, for example, a set of content to be delivered, an order in which the content is to be stored on the tangible media, label information, shipping information, payment information, and the like.

Once an order is received, media production engine 103 obtains content from data store 105 and produces a CD (or DVD, or other media-based storage) according to the order specification. The order specifies, for example, media type, media shape, media capacity, media life, media quality, content items, arrangement of content, file format for content, content encryption information, user certificates, volume label, disk label, package type, shipping type, customer identification, user identification, and the like. In a particular example, media production engine 103 creates an image of the CDROM to be produced and sends that image to duplication hardware 110. Alternatively, production engine 103 may create a list of file system pointers that are used by duplication hardware 110 to obtain specified content from file system 105 or, alternatively, from an external network accessible system such as customer server 121, or other network-accessible data service (not shown).

Duplication hardware 110 burns the specified data onto one or more disks. Optionally, duplication hardware verifies the disk after burning by reading back from the disk and comparing to the image or original data files. Verification is an option that may be specified by a user preference, or may be constrained as “always-verify”.

A single order may specify multiple disks to be produced. The disks within an order may each contain unique content and/or labels, or may be substantially identical. The disks within an order may comprise identical or varied media types (e.g., an order may include only CDs, or may include CDs, DVDs, etc.). The disks may be packaged together for shipping to a single recipient, or specified to package and ship one or more disks to different recipients. Any desired set of manufacturing process variables may be customized on a recipient-by-recipient basis. The order message format of the present invention allows this great degree of flexibility to meet the needs of varied applications.

Label unit 109 prints an order-specified label on the surface of the CD, and marks the disk with a unique identifier. Some or all of a label may be preprinted (e.g., by screen printing) in which case media selection processes ensure that the proper pre-printed media is provided to duplication hardware 110. When pre-printed media are used, additional text, graphics, and the like may be printed in conjunction with the pre-printed label to uniquely customized the CD by order, recipient, and the like.

The unique identifier is implemented as a visible or human-invisible indicia such as a barcode, tic marks, dot pattern, or other unique pattern on a surface of the CD. The invention is currently implemented using a barcode implementation that allows the identifier to be easily read by any machine that can be outfitted with a barcode scanner. It is contemplated that an identifier may also be implemented in the data recorded on the media. The indicia can be used to access order data from a datastore that tracks user, customer, and third party order information. In this manner unique identifier creates a persistent association between the order, and all of the data contained in the order, and the physical media produced by the order.

An important feature of the present invention involves the use of the unique identifier in post-production processes such as packaging 108 and shipping 107. The identifier allows any postproduction process to access order data associated with the particular disk. Hence, the disk becomes self-synchronizing with the manufacturing processes, in particular the post-production processes. Any post-production process such as packaging 108 and shipping 107, or potentially post-delivery processes at the recipient, can access order data simply by scanning the identifier and perform its function automatically or semi-automatically without need to re-identify and re-enter data that appears in the order specification.

The disk is passed to packaging unit 108 that uses the unique disk identifier to access packaging instructions associated with the order. Packaging instructions may specify a package type (e.g., jewel-case, sleeves, multi-CD packages and the like). Some types of media such as solid state media, DataPlay media and the like may be “packaged” in a device that actually uses the customized content. For example, the packaging may be a smart card, audio or multimedia player, or the like.

Also, packaging instructions may specify a group of CDs, that may or may not be identical, that are to be packaged together. This allows packaging operation 108 to scan each CD as it is produced and associate that CD with other CDs in a particular order. As it is contemplated that duplication 110 and label 109 processes may produce CDs out of order to improve efficiency, the ability to re-group produced CD's into groups specified by the user order is valuable. Regrouping may be done manually, or performed using automatic sorting equipment that can read the disk identifiers.

The disk is passed to shipping unit 107 that uses the unique disk identifier to access shipping and any other post-production instructions associated with the order. Using the unique disk identifier, customized shipping labels, postage, and the like can be automatically generated and applied. The packaged disk 108 is then shipped via the order-specified delivery service. In a particular example, the shipping system 107 is able to couple to computer systems of one or more delivery services to automatically place a pick-up and/or delivery order, obtain waybill and tracking numbers, and print the shipping labels with appropriate information for the order-specified delivery service. In this manner, the present invention enables very efficient use of personnel and resources in the shipping and delivery process. The present invention also optionally and automatically notifies a user, third party partners, or others of shipments, tracking information, and the like.

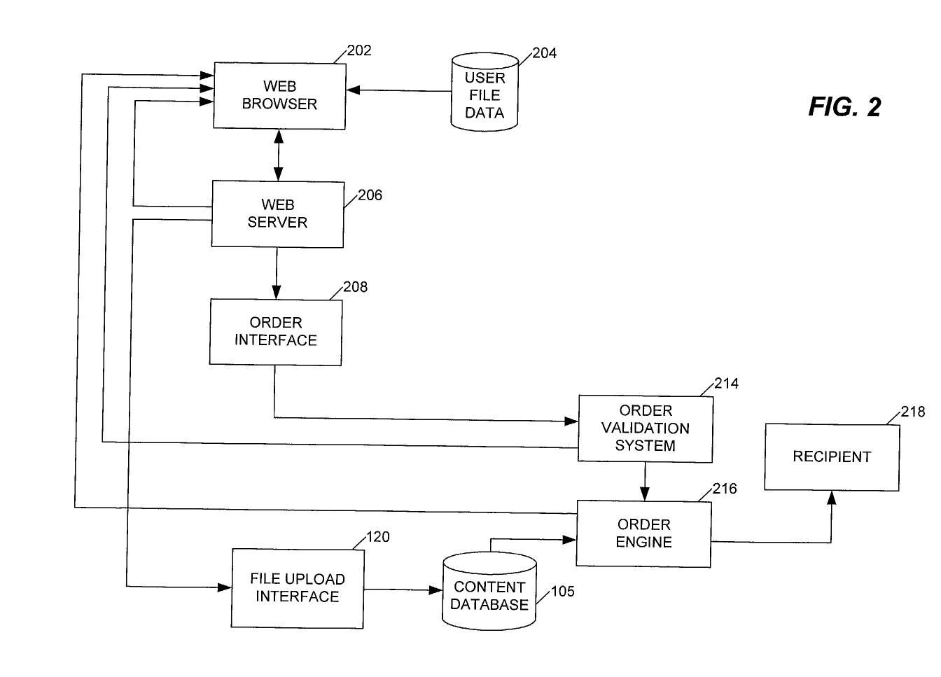

FIG. 2 shows an example of the production and distribution system of the present invention implementing the consumer system in FIG. 1. In this example, a portion or all of the content copied to the customized disk is provided by a user via file upload interface 120. Content may be stored in user data storage device(s) 204 such as hard disks, removable media and the like, or network storage devices accessible by the user.

Order data is input into a user interface such as web browser 202 or equivalent network communication mechanisms. The order data includes a specification of the content desired, and a specification of various preferences indicating how the content is to be provided. The order data includes data such as user account information, user/recipient address information, shipping, and user payment information among other user information. Order data may also include a list of files to be stored on the media-based storage and information to be used in the labeling, packaging and shipping of media-based storage.

Some manufacturing preferences may be previously stored or predefined by the system in accordance with the present invention, in which case the order data need not include the preferences, or may include a link to the previously stored information. For example, it is useful to store address lists comprising one or more recipient addresses in which case an order may point to a particular address list rather than specifying it with the order. Similarly, predefined label artwork, shipping preferences, shipping account information, and the like may be stored in advance of an order. The previously stored preferences may be applied to a particular order as a result of the order specifying the preference(s), or automatically without user input.

In one implementation, the order data includes various types of “immediate” data in which the order includes the actual data to be used by the system rather than a pointer to previously stored files. Using immediate data is a useful way of transferring text and graphics data for the label and package of the media, for example. This mechanism may be useful for communicating content as well.

Order data and content data are expected to be communicated asynchronously in that content may be uploaded at the nearly the same time an order is transmitted, or at any time before an order is placed. Both content and order data are sent to a server such as web server 206 that implements a front end to the manufacturing operation systems of the present invention. Server 206 is physically located at the production site in one implementation or may be physically located at the site of an Internet Service Provider (ISP) or other facility that remotely provides web site hosting and network connectivity to the production site.

The order data is sent to an order interface 208 that is located at the production facility. The content is sent to a file upload interface 210 that may associate the content with a unique user or customer and then stores the content in content data store 105. Content data store 105 can be implemented in any available data storage mechanism of suitable size including relational and object-oriented databases, flat file storage, hierarchical file systems, and the like. Content data store 105 may comprise a unified data structure, or multiple independent data structures to meet the needs of a particular application. In a typical application, data store 105 may include structures for holding a variety of data in addition to content, such as customer information, working data structures used by media production engine 103 and/or server 102, accounting data and the like.

Order data is sent to order validation system 214 that checks the order data for errors, such as mistyped data fields and missing data fields. Any errors that are found in the order data may be logged and reported back to the customer, user and/or operator at the production site. In one preferred example, when an error in the order data is discovered by the order validation system 214, a check is made to see if the order requires a feedback message for the error. If a feedback message is required, the order validation system 214 may alert the user, customer and/or production site operator, or any other interested party with an email, log file entry, HTTP message or the like containing the contents of the feedback message.

The validation system 214 may also includes the ability to compare a request in the order data for files to be copied onto customized data disk with files sent by the user and located in databases accessible by the order engine 216 to ensure that all the files are available for copying. In another implementation, the validation system 214 includes confirmation of user payment as well as the matching of each order to an order receipt that is sent to the user.

Once the order data has been validated by the order validation system 214 it passes to the order engine 216, where it is incorporated into the production, labeling, packaging and shipping of the fixed, digital storage media. The media are distributed to the recipient 218 via a mailing or courier service such as United Parcel Service, Federal Express or the postal service, among others. Alternatively, the recipient can pick up the customized media at the production facility, or at a regional distribution center of the production facility or third party partner, or be delivered to the recipient using any other deliver technique suitable to a particular application.

In one embodiment of the present invention, the user can send order data that specifies the production and shipment of copies of the customized data disk to one or more recipients 218 at separate addresses. This one-to-many feature of the present invention provides time savings to a user who can have multiple copies of a customized data disk sent to multiple recipients using one order. In another embodiment, the order data may specify multiple identical or unique CDs that are packaged and shipped together to one or more recipients. This many CDs-to-one order feature reduces shipping and handling costs.

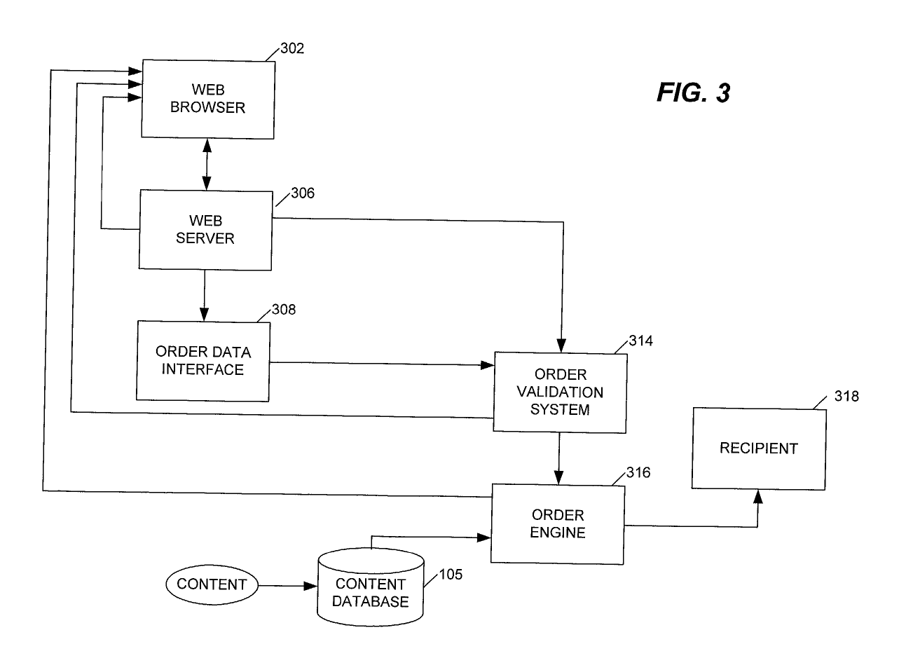

Referring now to FIG. 3, another example of a functional system architecture diagram for allowing a web user to create a customized data disk is shown. In this example, a web user may order a customized data disk comprising content from third-party partners that is previously stored in content data store 105. A user orders a customized data disk by inputting order data directly to a server 306 or indirectly through a customer server 121 (shown in FIG. 1) using, for example an HTML form presented by a user interface such as web browser 302 or other interface to servers 306/121. The order data includes a selection of third-party partner content that the user desires to be copied onto the customized data disk.

The order data is communicated through a network interface such as web server 306 to an order interface 308. Order interface 308 formats order data into a form used by the order validation system 314. Although the implementation of FIG. 2 and FIG. 3 are presented separately for clarity, it should be understood that once an order is received, it is contemplated that the order will be handled in substantially the same manner irrespective of its source. Hence, many of the mechanisms shown in FIG. 3 may be integrated with, or in practice identical to the mechanisms shown in FIG. 2.

Order data is sent to an order validation system 314. Feedback, if required by the particular order, is sent to the user that the order has been validated and that it will be processed and shipped to the recipient 318. The order validation notification is sent to the user via an email message, HTTP message, or the like.

The validated order data is sent from the validation system 314 to the order engine 316 where the order is fulfilled. The third-party content is stored in content data store 105.

The file data stored on the database 312 is uploaded to the file data database 312 via a communication link, such as a phone line or high-speed data link to a data storage device controlled by the third-party partner. The file data may also be uploaded to the file data database 312 via fixed storage media such as DLT or DAT tapes, FireWire storage devices, and optical data storage disks included CD and DVD disk, among others. In another preferred aspect that is not shown in FIG. 2, a file server that supplies the file data for the customized data disk and operated by the third-party partner is connected directly to the order engine 316.

At the order engine 316, the file data is copied to the customized data disk and a label is formed on the disk. In a preferred aspect, the disk label is selected by the web user from a choice of disk labels made available by a third-party partner. In another preferred aspect, the web user supplies a portion of the graphics and/or text of the label while the third-party partner supplies the substantial remainder. In another preferred aspect, the web user supplies substantially all the graphics and/or text for the label. Once the customized data disk is copied, labeled, packaged and prepared for shipping, it is distributed to the recipient(s) 318 using an available, order-specified distribution method.

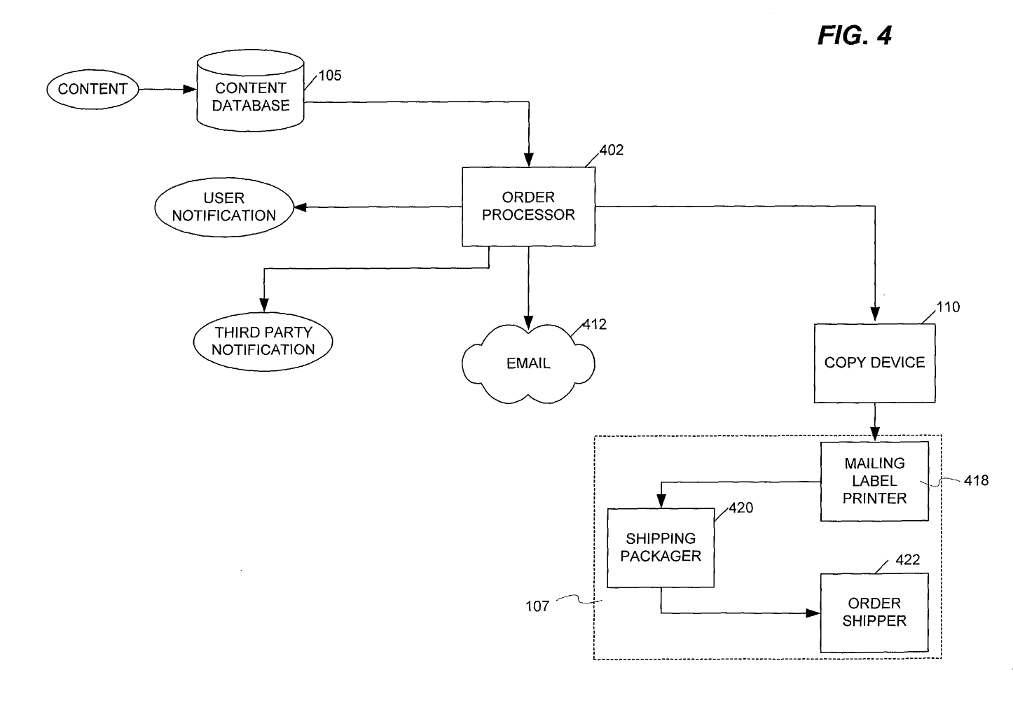

Referring now to FIG. 4, an example of the order production system 400 of the present invention is shown. In this example, the order production system, also called the order engine, comprises an order processor 402 that receives order data from the order validation system (not shown) and content from content data store 105. The order processor 402 may format the content into a format that can be copied by a copy device 416 onto a blank disk. For example, content may be stored in a compressed form in content database 105 and decompressed before being copied onto the customized CD. Similarly, order processor 402 may encrypt content before being copied onto the customized CD. Also, content may be customized in a manner akin to mail merge operations. For example, the base content or template content is customized by adding recipient-specific information into the base content before it is written to the customized data disk. In this manner, a marketing presentation could be customized from a template by adding in recipient-specific information. In another example, a music CD may be customized by adding in inaudible recipient-identification information to one or more tracks on the CD, making the disk and/or each track uniquely identifiable.

The copy device 416 may include CD and DVD duplication and color graphic label printing devices. Copy device 416 may be implemented by, for example automated duplicators made by Rimage Corporation, Microtech Systems, Mediaform, Inc. and others. Label printers used in label operation 109 are preferably integrated with the duplicator in copy device 110, although duplication and label printing may be provided as separate devices.

Shipping operation 107 comprises a number of operations that, based on the order data retrieved through the identifying indicia, group multi-disk orders together, package the disk(s) for an order into a specified container such as a case or sleeve, and initiate delivery. Multiple disk orders are grouped by reading the indicia on each disk and accessing the order data associated with the disk/indicia. The order data will indicate which disks should be grouped together, and make it easy to determine when all the disks in a particular order have been produced and bundled together.

Disks may be packaged in multi-disk containers or single-disk containers. Disk cases include generic disk storage cases as well as customizable cases that have graphics and text selected by the web user and/or third party partner.

A mailing label that includes the shipping address for the customized disk is printed by a mailing label printer 418. The mailing label printer 418 typically provides a standard mailing label that conforms to the requirements of the selected shipping service, and may include customizable text and graphics selected by the web user and/or third party partner. Mailing labels may be provided using printers manufactured by Zebra Technologies, Epson, and a variety of other manufacturers.

The packaged, customized disk(s) is(are) then packaged by a shipping packager 420, which includes affixing the mailing label to the shipping package. As described above, the package may be shipped 422 via a mailing or courier service such as United Parcel Service, Federal Express or the postal service, among others. The order data, as retrieved by the disk indicia, is used to determine order-specified shipping preferences such as carrier selection, service level and the like. In a particular implementation, the order data is used to automatically or semi-automatically access an online computer interface of the shipper and place the pickup/delivery order with the shipping service.

The order processor 402 may notify a user at one or more stage of the production, packaging and shipping of the customized disk. The notification messages include, for example, information on the time that a stage of an order has been completed or the third party shipper tracking ID. The order processor 402 also may send notifications to a third party when such notification is specified by an order.

Notifications may be sent as email messages 412 to a user's email address, a third party partner's email address and/or a recipient's email address. The email messages 412 may include confirmation information indicating that an order has been received, shipping information, billing information, and the like. The notification email messages 412 may also include tracking information that indicates how a shipment can be tracked through the shipper. In addition to email messaging, notifications may be sent by FTP, HTTP, or other available protocol or combination of protocols.

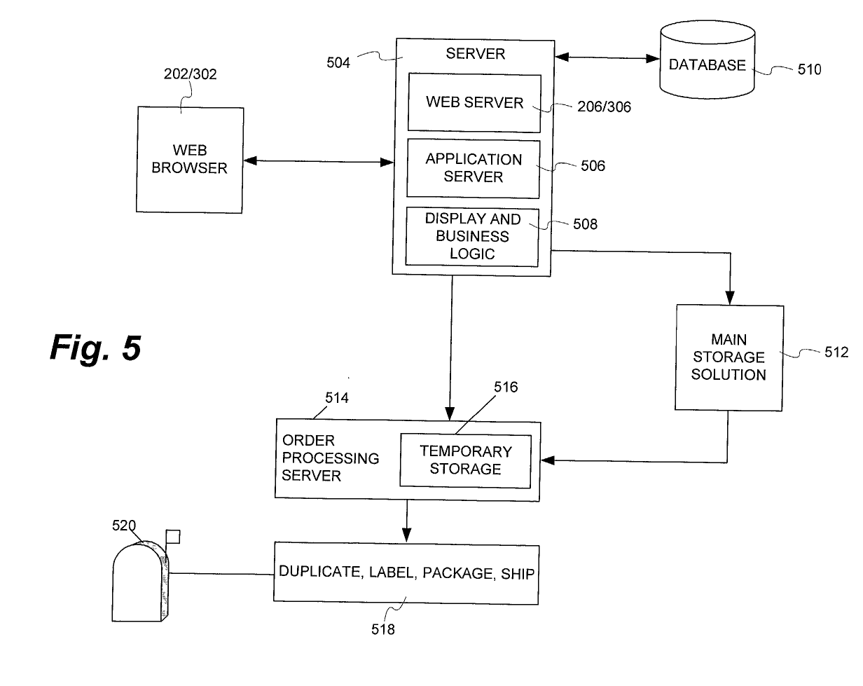

FIG. 5 illustrates another view of an implementation of the present invention. In FIG. 5, a user places an order through, for example, a web page presented on the user's network interface such as web browser 202/302 to a server 504. The server 504 can host web server 206/306, application server 506 and/or display and business logic 506. Server 504 may also host one or more database servers that implement database 510, data store 105, and/or other data storage mechanisms used by a particular application. Alternatively, each of these services can be implemented on one or more separate hardware platform.

Application server 506 hosts any number of support applications that are utilized by display and business logic applications. For example, server 504 may support applications including user account applications, login and verification applications, storage service management applications, market trending applications, billing services applications, purchase tracking applications, and shipping service applications among others. These support applications running on the server 504 are preferably generic to the display and business logic applications running on the display and business logic 508, and also may have readily accessible application program interfaces (APIs) to integrate with existing and future display and business logic applications.

In this example of the system of the present invention, a data store 510 coupled to web server 504 stores a variety of user account information, including purchase history, shipping and billing information, and user verification information among other kinds of information. Data store 510 may also contains information about third party partners and the data they are supplying to the main storage solution 512.

Server 504, application server 506 and display and business logic server 508 may access information in the data store 510 to verify and organize orders from users. For example, when a user sends an order to server 504, information in data store 510 is used by the server 504 to verify the user's authenticity, provide the user with previously entered billing and shipping information, and confirm that any content that will be supplied is available. Data store 510 may also store user and third-party preferences (e.g., shipping carrier, media type and the like) that are used to augment preferences specified in the order data. Data store 510 can also store files uploaded by the web user via the Internet that are ultimately copied to the customized disk.

Main storage solution 512 is implemented by, for example, a large database or file system that stores content from web users and third party partners that can be sent to temporary storage 516 in the order processing server 514 and then copied to customized data disks. Hence, main storage solution 512 is used to implement content data store 105 discussed in other examples. Alternatively, main storage solution 512 can supply content directly to order processing server 514, eliminating the need for temporary storage 516. The main storage solution 512 comprises an array of file servers connected to the Internet, and may be hosted by a third-party service that specializes high volume data storage and retrieval.

The data from users and third party partners can be transported to main storage solution 512 by, for example, data transfer through a user's web browser 202/302 and the public internet (e.g., FTP or HTTP/HTTPS), virtual private networks, network connections to third party partners, DLT or DAT tapes, FireWire storage devices, and optical data storage disk, among others. The main storage solution 512 may be located at a facility that specializes in large data storage solutions, the site of the customizable disk production facility, or the site of the server 504, among other locations.

In the example shown in FIG. 5, order data is sent from the server 504 to the order processing server 514 and content is sent from the main storage solution 512 to temporary storage 516 in the order processing server 514. It should be appreciated that there are numerous variations on the transfer of order and content to the order processing server 514, including sending both the order data and the content from the server 504, and supplying both order data and content from the main storage solution 512 to the order processing server 514, bypassing temporary storage 516. Moreover, additional system components can be envisioned that further format and process the order data and/or file data before they reach the manufacturing operations 518 which are performed in accordance with order specifications and preferences. After operations 518, disks are shipped to the recipient 520.

The system of the present invention includes a number of security and encryption features. For example, the system may include storage encryption for sensitive content. The system also may include transaction encryption to protect sensitive data being transmitted by users and third-party partners.

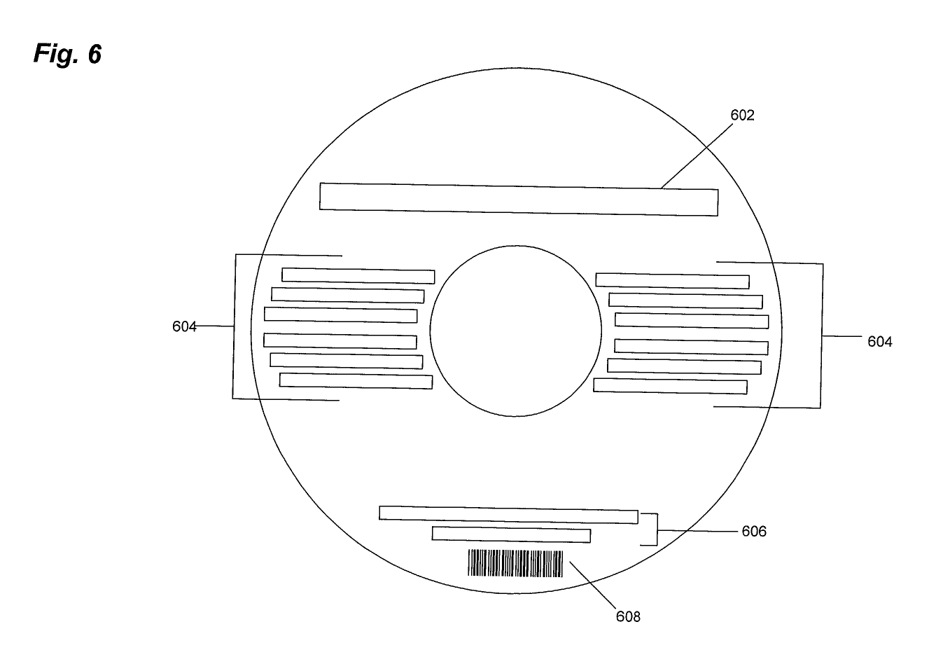

FIG. 6 shows an example disk label template 600 of the present invention. The template 600 includes text fields for the disk title 602, the disk content 604, the disk subtitle 606, and a barcode 608 or some other identifying indicia that uniquely identifies the disk. In one example, template 600 can be displayed as a web form so a user can enter text data into the title box 602, content boxes 604 and subtitle boxes 606 that will be printed onto the customizable data disk at the production site. In another example, the title box 602, content boxes 604 and subtitle boxes 606 are automatically populated when a user selects a file to be copied on the customizable data disk. For example, when the user selects a music file to be copied on the customizable data disk, the title box 602 is automatically populated with the music artist, a content box 604 is populated with the song title corresponding to the music file, and the subtitle box 606 is automatically populated with customized text (e.g., recipient name passed in with the order data) and/or copyright information pertaining to the music file.

The system described herein emphasizes user control over process variables in a manufacturing environment. The user expresses preferences, which are captured and supplied to a manufacturing facility in the form of an order message. While the present invention enables any number of process variables to be controlled in this manner, it is contemplated that in many instances the user control will be constrained by predefining certain preferences or otherwise preventing the user from controlling these variables.

Similarly, some manufacturing variables may be controlled implicitly or indirectly based upon either explicit user preferences, explicit pre-stored preferences, or properties of the content itself. For example, music tracks from a particular source may require a “red book” format. Similarly, content from a particular third party server 121 may require or imply the need for particular preprocessing or post processing (e.g., to arrange photographs into an album, or manual pages into a particular order, or bundling software into particular collection). This format should be used irrespective of whether the order explicitly calls for this format. Accordingly, when the order processor is working with this type of content, the preference is implicitly applied against the order as it is manufactured. This feature may apply to any manufacturing variable such as duplication, labeling, packaging and shipping.

Although the present invention has been presented as a system that produces tangible media at a centralized location, several features of the present invention may be useful even where the tangible media is produced at a different location (e.g., by the customer, or by the user/recipient) or even in cases where the compilation is never reduced to a CD at all. The order system in accordance with the present invention enables a user to specify a group of content and various preferences that may result in the creation of customized compilation of content or image file that has user-selected content, arrangement, formatting, and the like, that can then be delivered in electronic form. The compilation or image file may carry electronic indicia linking it to the order placed. This electronic file may be stored on a hard drive, CD, DVD, tape, or the like at a later time. Such an implementation is useful in that it allows users an ability to select and bundle content (e.g., software, related manuals and documentation), and deliver that bundled content to one or more specified recipients.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A controller for managing storage, duplication and distribution of digital content on physical media, the system comprising:
an interface for receiving order messages from a network, wherein each order message includes order data that specifies digital content and specifies order preferences;
a duplicator in communication with the interface and operable to place the specified digital content onto the physical media in accordance with the specified order preferences;
a labeler that places a label and an identifying indicia on the data disk, where the indicia creates an association between the disk and corresponding order data;
at least one post-duplication process that is automated using the indicia to access the order data associated with a disk.

2. The system of claim 1 wherein the order message specifies the digital content by identifying a file where the content is stored.

3. The system of claim 1 wherein the order message specifies the digital content by including the digital content within the order.

4. The system of claim 1 wherein the specified preferences include a value indicating a type of media to be used for the physical media.

5. The system of claim 1 wherein the specified preferences include a value indicating a label information to be used by the labeler.

6. The system of claim 1 wherein the specified preferences include a value indicating a quantity of physical media to be used to fulfill the entire order.

7. The system of claim 1 wherein the specified preferences include a value indicating shipping method to be used to deliver the physical media to one or more recipient(s), and the at least one post5 duplication process includes:
reading the indicia;
accessing a record of the order message using the indicia;
obtaining the shipping method from the record of the order message; and
shipping the media according to the orderspecified preference.

8. The system of claim 8 further comprising:
automatically placing a shipping order with a third-party parcel delivery service by communicating at least some of the order-specified preferences with the third-party parcel delivery service.

9. The system of claim 8 further comprising:
printing a shipping label using the order-specified preferences.

10. The system of claim 1 wherein the specified preferences include a value indicating a type of packaging to be used for the media, and the at least one post-duplication process includes packaging the media according to the order-specified preference.

11. The system of claim 1, wherein the system comprises a browser for the input of order data from a network user.

12. The system of claim 1, wherein the duplicator comprises an order processing server and a temporary storage, wherein the order processing server receives the order data from the interface and the temporary storage is in electronic communication with the database.

13. The system of claim 1, wherein the interface comprises a web server.

14. The system of claim 1, wherein the physical media is selected from the group consisting of: a optical disk, magnetic disk, magneto-optic disk, magnetic tape, optical tape, magneto-optical tape, and read only memory.

15. The system of claim 1, wherein the content comprises music files.

16. The system of claim 1, wherein the content comprises graphics files.

17. The system of claim 1 wherein the content comprises billing records.

18. The system of claim 1, wherein the identifying indicia comprises a barcode.

19. The system of claim 18 wherein the barcode is invisible to humans

20. A customized data disk production, packaging and shipping system comprising:
a first server having a network interface for receiving order data, the order data comprising values specifying one or more customized data disks to be produced, packaged and shipped in fulfilling the order;
a second server having a network interface for providing order data over the network to the first server;
an order processing unit in the first server and coupled to receive the order data and manage an order record associated with the order data;
a disk production station in communication with the order processing server, wherein the disk production station outputs a produced disk and comprises means for associating each produced disk with a specific order record;
a disk packaging station in communication with the order processing server and configured to receive a disk produced by the disk production station, wherein the disk packaging station comprises means for accessing the order record associated with a received disk and performing a disk packaging operation in accordance with order data in the order record; and
a shipping station in communication with the order processing server and configured to receive a packaged disk from the disk packaging station, wherein the shipping station comprises means for accessing the order record associated with a packaged disk and performing a shipping operation in accordance with order data in the order record.

21. The system of claim 20 wherein the disk production system comprises a label printing device that prints an identifying indicia on the customized data disk.

22. The system of claim 20 further comprising a client having a network interface for providing order data over the network to the first server.

23. The system of claim 20 further comprising:
a client having a network interface for providing order data over the network to the second server; and
processes within the second server operable to cause the order data to be communicated to the first server.

24. The system of claim 20, wherein the shipping station comprises:
an interface to a third party delivery service for automatically placing a delivery order using the order data in the order record.

25. The system of claim 24, wherein the shipping station comprises:
a shipping label printer operable to automatically print a waybill using the order data in the order record in combination with delivery data obtained through the interface to a third party delivery service.

26. A customized data disk production process comprising:
receiving order data from a user, the order data comprising one or more content selections and one or more preferences;
selecting at least one blank media based upon the preferences;
placing content the selected blank media based upon the content selection to produce a customized data disk;
placing linking information on the customized data disk to persistently link the customized data disk with the associated order data; and
performing at least one post-production process by retrieving the order data using the linking information.

27. The method of claim 26 wherein the at least one post-production process comprises sending a notification message as specified in the order data.

28. The method of claim 26 wherein the at least one post-production process comprises placing a label on a surface of the customized data disk.

29. The method of claim 26 wherein the at least one post-production process comprises automatically generating a customized shipping label per the order specification.

30. The method of claim 26 wherein the at least one post-production process comprises automatically registering a shipping order with a third party delivery service.

31. The method of claim 26 wherein the at least one post-production process comprises aggregating multiple customized data disks into a single shipping order.

32. The method of claim 26 wherein the at least one post-production process comprises shipping a data disk to each of multiple recipients specified in the order data.

33. An electronic order for a customized media comprising:
content selection information; and
fulfillment preference information.

34. A service for processing orders for customized media production, the service comprising:
a first network interface for receiving orders for customized media production directly from network-connected client machines operated by an ordering user;
a second network interface for receiving orders for customized media production indirectly through a third-party service, wherein the third party service is in communication with the ordering user.

35. A customized media-based storage article comprising:
a data storage media having content stored thereon; and
an indicia on the media to uniquely associate the media with order data used to manufacture the media, wherein the order data was used to customize at least one process in the manufacturing, packaging, and shipping of the media.
